(19) United States
(12) Patent Application Publication
(10) Pub. No.: US 2021/0086329 A1
(43) Pub. Date: Mar. 25, 2021

(54) CLAMPING ELEMENT AND MACHINING DEVICE COMPRISING THE SAME

(71) Applicant: HOMAG Bohrsysteme GmbH, Herzebrock-Clarholz (DE)

(72) Inventor: Daniel SCHRAMM, Rheda-Wienbrück (DE)

(21) Appl. No.: 16/975,107

(22) PCT Filed: Feb. 20, 2019
(86) PCT No.: PCT/EP2019/054185

§ 371 Date: Aug. 21, 2020

(30) Foreign Application Priority Data
Feb. 23, 2018 (DE) 10 2018 202 774.9

(51) Int. Cl. B25B 11/00

(52) U.S. Cl. CPC B25B 11/005

(57) ABSTRACT

The invention relates to a clamping element, in particular a vacuum cup, which is used, for example, for holding a plate-shaped workpiece. The clamping element comprises a unit which is configured to detect individualised control signals transmitted via the power supply and to control the drive unit.

### TECHNICAL FIELD

The invention relates to a clamping element (in particular a vacuum cup) which is, for example, used for holding a plate-shaped workpiece. The invention also relates to a machining device having a clamping element. Such a machining device is used in the furniture and components industry, for example, for machining workpieces preferably made of wood, wood-based materials, composite materials or similar.

### PRIOR ART

In the field of wood machining devices, machines with so-called console tables are known. Such console tables comprise beam-like consoles on which clamping elements (vacuum cups; vacuum blocks) can be positioned. The position of the clamping elements on a console and, where appropriate, the placement of the console itself is selected depending on the particular application, in particular depending on the size of the workpiece to be machined and on the machining steps to be carried out.

Systems are known in which the clamping elements are manually prepared (positioned on the console). The clamping elements are placed in a particular position on the console using a ruler, for example, or a similar positioning aid. Once the clamping elements, which are designed as vacuum cups, have been placed on the respective console, the magnetic valves underneath open, which facilitates the holding/clamping of a workpiece.

Also known are machining devices in which the clamping elements are moved to their respective positions on the console by means of a drive. However, costs increase on account of such drive systems, and the amount of maintenance required also generally increases.

The document EP 2 992 993 A1 relates to a device and a method for positioning a clamping element. The device comprises at least one positioning element which is configured to indicate the desired position for a movable clamping element. The clamping element comprises a position detecting device which is configured to provide the machining station with a signal comprising the actual position of the clamping element.

In one embodiment according to EP 2 992 993 A1, provision is made for each clamping element to be equipped with a separate drive, which allows positioning at least within a defined tolerance range. According to this embodiment a generally complex feed system, which covers the entire machining table and therefore necessitates a greater amount of space in the machining station, is omitted. Furthermore, maintenance is simplified in the case of a clamping element having its own drive since it is possible to maintain individual clamping elements simply by replacing them, without causing downtime of the machining station. Possible drives include, for example, actuators, compressed air-powered drives and vacuum-operated drives.

### SUBJECT MATTER OF THE INVENTION

An object of the present invention is to provide a clamping element and a machining device, wherein the positioning of the clamping element, or preferably of a plurality of clamping elements, on a console is intended to be implemented in a structurally simpler manner.

The subject matter of claim 1 provides a corresponding clamping element. Further preferred embodiments are described in the dependent claims.

Moreover, the present invention relates to a machining device having a clamping element and to a method for moving a clamping element along a console. Individual features of the dependent claims can be combined with any of the independent claims.

The clamping element, which is preferably designed as a vacuum clamp, comprises a contact area on which a section of a workpiece can be placed, and at least one drive unit for moving the clamping element along a console of a machining device. The clamping element also comprises a unit which is configured to detect individualised control signals and to control the drive unit. The control signals are transmitted via the power supply, in particular via a strip conductor/bus bar. The control signal can be modulated on the strip conductor/bus bar.

In this context, controlling the drive unit may mean that the drive unit is activated or switched on, for example. Further information, such as the speed, end position etc. of the drive unit can also be specified.

The unit for detecting control signals may comprise a decoder or it may be designed as a decoder.

The present invention has the advantage that the number of clamping elements per console can be increased without significantly changing the complexity of the system. Moreover, moderate production costs can be achieved. Even if instead of the motorised adjustment of the clamping element in terms of the positioning thereof which is preferred within the scope of the invention such an implementation is not desired in the specific case at issue, the clamping element which can be driven by way of a motor can be manually positioned.

Since the unit of the clamping element responds to individualised control signals, it is possible to control, and optionally to move, the specific clamping element. Thus, where a plurality of clamping elements are arranged on a machining device or on a console of a machining device, these can each be controlled individually.

A workpiece that is held/positioned with the clamping element can be moved using the clamping element from a position which is optimal for manual placement to a position that is more advantageous for machining the workpiece. In this way, the machine can be operated better and more easily.

Furthermore, it is possible to move the clamping element to a specific position before a workpiece is mounted. If a plurality of clamping elements is provided on a machining device, these can be individually positioned depending on the workpiece or depending on the machining to be carried out.

If the clamping element is designed as a vacuum clamp, an opening is provided on the contact area, which opening is connected to a vacuum source. A seal may also be applied to the contact area.

According to a preferred embodiment, the drive unit comprises an engagement element, in particular a gear wheel, in order to be able to move the clamping element relative to the console. Alternatively, the drive unit may be designed as a linear motor, so that there is a contactless drive.

The clamping element may comprise a base with protruding sections which are configured to cover side walls of the console in sections. In this way, the clamping element can be secured to a console.

It is preferred that the unit for detecting control signals is connected to a sliding contact. This allows the unit (or the decoder) to receive control signals which are provided to the drive unit via the power supply.

According to one embodiment, the drive unit is an electric drive unit.

It is preferred that the clamping element comprises two or more drive units, wherein the two or more drive units are configured to act at opposite sides of the console. This prevents the clamping element from becoming jammed on the console. The drive units may each comprise a gear wheel, for example, which is driven by a motor.

In one embodiment, provision is made for the unit for detecting control signals to be configured to connect, based on an activation key, the drive unit of the clamping element to a strip conductor of the console, or to activate the drive unit in order to move the clamping element. The activation key can be in the form of NRZ encoding, RZ encoding or Manchester encoding. Since the unit for detecting control signals of the clamping element responds to control signals individualised by an activation key, it is possible to control the specific clamping element.

According to a further object of the invention, a machining device for machining a preferably plate-shaped workpiece is provided. The machining device comprises a machining table having at least one console extending in a first direction, and at least one clamping element, wherein the clamping element comprises a drive unit for moving the clamping element along the console. Moreover, provision is made for the clamping element to comprise a unit for detecting control signals which is configured to detect individualised control signals and to control the drive unit. The control signals are transmitted via the power supply, in particular via a strip conductor/bus bar. The control signal can be modulated on the strip conductor/bus bar.

Preferably, the machining device comprises a plurality of clamping elements on the console, wherein it is also preferable for the clamping elements to be provided on the console in a detachable manner. According to a further embodiment, the machining device comprises a plurality of consoles, on each of which a plurality of clamping elements can be, or are, mounted, preferably in a detachable manner.

It is preferred that a strip conductor extends along the console, wherein a sliding contact of the clamping element is connected to the strip conductor. This allows the drive unit of the clamping element to be supplied with power.

Alternatively, a contactless power transmission where the power transmission takes place inductively, for example, can be provided. The amount of transmitted power does not necessarily have to be high since the clamping element is usually still and is only moved to change position.

In one embodiment, provision is made for a modular unit to extend along the console, which modular unit comprises a grid with which an engagement element of the drive unit can engage. Thus, a contact point for the drive unit of the clamping element is provided in an inexpensive manner.

It is preferred that the clamping element comprises two or more drive units, wherein the two or more drive units are configured to act at opposite sides of the console. This prevents the clamping element from becoming jammed on the console.

In a variant of the invention, provision is made for the machining device to comprise a control unit having an encoder, in order to modulate control signals for controlling the drive unit. The control signals modulated by the encoder for example on the power supply (strip conductor) for the drive unit can be received by the unit for detecting control signals of the clamping element and can be interpreted accordingly. The control signals are individualised, such that a specific clamping element is addressed by a specific control signal. It is thereby possible to control and move the clamping elements individually or independently from one another.

It is preferable for the console to be able to be moved along the machining table in a second direction, wherein it is preferable for a movement of the clamping element and the console to occur simultaneously at times. The movement can be initiated by the control unit of the machining device, such that the movement of the clamping element on the console and the movement of the console are performed in a coordinated manner.

Furthermore, the invention relates to a method for moving a clamping element along a console, wherein the clamping element comprises a drive unit for moving the clamping element and a unit for detecting individualised control signals transmitted via the power supply, comprising: detecting a control signal by means of the unit, and controlling the drive unit based on the control signal detected by the unit.

Features of the clamping element or of the machining device which have already been mentioned above or which are set out in the claims below can be used within the scope of the method.

### BRIEF DESCRIPTION OF THE DRAWINGS

FIG. 1 shows a clamping element according to an embodiment of the invention on a console of a machining device.

FIG. 2 shows a machining device having a plurality of clamping elements.

### DETAILED DESCRIPTION OF THE PREFERRED EMBODIMENT

In the following, a preferred embodiment of the invention will be described in detail on the basis of the enclosed drawings. Further modifications cited in this context of certain features can each individually be combined in order to form further embodiments of the invention.

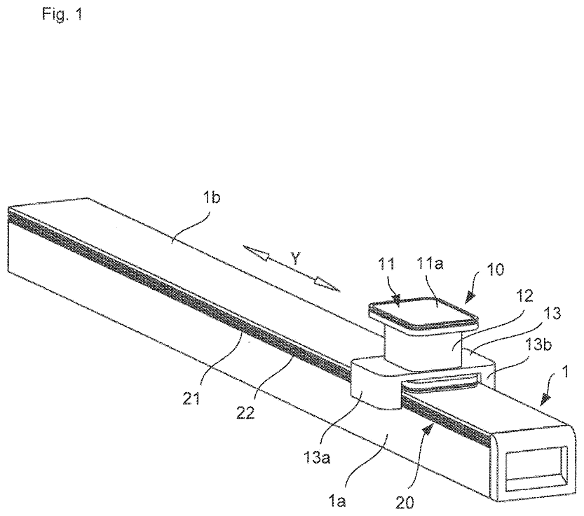

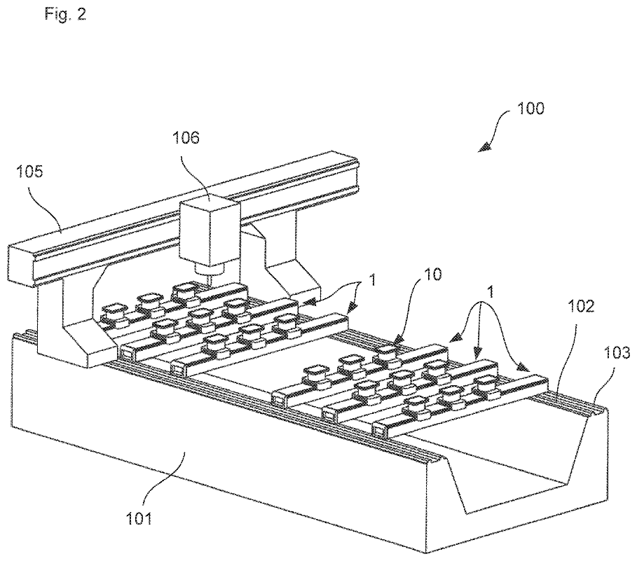

The console 1 shown in FIG. 1 is part of a machining table of a machining device 100. The machining device 100 shown in FIG. 2 comprises a machine bed 101 which is provided with guides 102 for a plurality of consoles 1. The consoles 1 can be moved along the guides 102 in a translational direction.

Moreover, further guides 103 are attached on the machine bed 101 for a gantry 105. A machining assembly 106 can be moved along the gantry 105. Milling or drilling, for example, can be performed on a workpiece using the machining assembly 106.

In the following, a console 1 will be described in more detail on the basis of the view shown in FIG. 1.

A clamping element 10 is positioned on a contact face 1b of the console 1, which, as will be described in more detail in the following, can be moved along the Y direction (longitudinal direction of the console 1). In another application, the clamping element 10 can be detached from the console 1 and manually positioned on the contact face 1b of the console 1.

Moreover, a plurality of clamping elements (two, three or more, for example) may be provided on the console 1. An exemplary number of three clamping elements 10 is shown on the consoles 1 shown in FIG. 2; the number of clamping elements may be different, however. For the sake of clarity, just one clamping element 10 is shown in FIG. 1.

A modular element 20 is provided on each of two opposite side sections of the console 1 (just one side section 1a with a corresponding modular element 20 is shown in FIG. 1). In the present embodiment, the modular element 20 is connected (e.g. screwed) to the console 1, but may also be formed in part integrally with the console 1.

The modular element 20 comprises a strip conductor 21 and a grid 22. The strip conductor 21 is provided for transmitting power and data, while the grid 22 provides engagement sections for a drive unit provided on the clamping element 10.

In the present embodiment example, the strip conductor 21 and the grid 22 are arranged parallel to one another, although the strip conductor 21 and the grid 22 may also be formed as a common section, wherein this common section serves both as a grid and as a strip conductor.

The clamping element 10 comprises a contact area 11 on which a section of a plate-shaped workpiece, for example, can be placed. Such a plate-shaped workpiece may be, for example, a wooden panel, a chipboard panel, an MDF panel, an HDF panel, a panel made of composite material or similar.

Attached to the contact area 11 is a sealing element 11a, which surrounds an outer edge of the contact area 11. Furthermore, at least one vacuum opening is provided in the contact area 11, such that when the workpiece is mounted a vacuum is formed in the area of the clamping element 10 delimited by the sealing element 11a.

The contact area 11 of the clamping element 10 is supported by a support 12, which in turn is attached to a base 13. As in the case of the present embodiment example, the contact area 11, the support 12 and the base 13 can be formed of a plurality of parts or as one part.

Owing to protruding sections 13a, 13b, the base 13 is designed to be wider than the width of the contact face 1b of the console 1. Thus, the protruding sections 13a, 13b of the base 13 protrude beyond the side sections 1a of the console 1 when the clamping element 10 is mounted on a contact face 1b of the console 1.

Above this, the protruding sections 13a, 13b of the base 13 extend along the respective side section 1a of the console 1 and beyond the modular element 20 when the clamping element 10 is mounted on the console 1. Thus, the base 13 of the clamping element 10 surrounds the console 1 in sections.

A drive unit is provided in each of the sections 13a, 13b of the base 13, which is in contact with the strip conductor 21 via a sliding contact and which engages with the grid 22 of the modular element 20 by way of a respective engagement element (e.g. a gear wheel, not shown). Since the drive units are provided in sections 13a, 13b and therefore on both sides and since the drive movements thereof are synchronised, the clamping element 10 is prevented from jamming during the movement thereof along the console 1.

The respective drive unit comprises one or two electric motors per side, an electronic control unit in which a unit for detecting control signals (decoder) which may comprise a decoder, for example, is located, and optionally one or more additional devices for determining the position of the clamping element 10 on the console 1. The unit for detecting control signals interprets signals transmitted via the strip conductor 21 and received by the sliding contacts. If an individualised signal is detected, the unit for detecting control signals can, for example, control or activate the drive units of the clamping element, such that the clamping element is moved and re-positioned.

Moreover, according to a further modification it is possible to provide a drive unit in the base 13, for example in the centre thereof, wherein an engagement element (such as a gear wheel) is provided on both sides in the region of sections 13a, 13b of the base 13. The engagement elements are connected to one another via a gear mechanism and in this way they can be operated synchronously.

A permanent voltage (12V, for example) is applied to the strip conductor 21. The unit for detecting control signals (decoder) separates, in idle mode, the voltage from the drive unit of the clamping element 10 (the electric motors). Where necessary, information in the form of bits is transmitted on the strip conductor 21 by means of an external control unit, such as a control unit of the machining device 100. This is achieved by way of NRZ, RZ or Manchester encoding. In this way, it is ensured that a specific clamping element can be addressed.

In order for a desired clamping element 10 to respond, the data sets must initially contain a corresponding key which is uniquely assigned. If an activation key is detected by a unit for detecting control signals of a clamping element 10, the drive unit of the corresponding clamping element (electric motors) is connected to the strip conductor 21 and the clamping element 10 is moved.

Thus, any number of clamping elements 10 can be moved along the console 1 independently from one another by a control unit of the machining device transmitting one or more signals, in each case corresponding to a clamping element 10, via the strip conductor 21 and the respective sliding contact to the unit for detecting control signals, which in turn controls the respective drive unit.

According to a method of the invention, the position of a clamping element 10 on a contact face 1b of the console 1 is adjusted as follows.

A desired positioning of one or more clamping elements is input manually or on the basis of set-up data in a control program of the machining device. In order to achieve the positioning of the one or more clamping elements, the respective console can first of all be moved along the machine bed 101 if necessary.

Simultaneously, or subsequent to the movement of the console 1, the clamping element 10 (or plurality of clamping elements) provided on the console 1 is moved by modulating control signals on the electric strip conductors 21, which signals can be read out by the unit for detecting control signals of a drive unit of the clamping element. The activation or deactivation of a respective drive unit of the clamping element 10 is carried out based on the output of the unit for detecting control signals.

Although in the context of the present embodiment a grid 22 has been described for providing an engagement area for an engagement element, in order to ensure the movability of the clamping element 10 it is also possible to provide for the movement of the clamping element along the console by way of a linear motor.

Although the clamping element according to the present embodiment is designed as a vacuum cup/vacuum block, according to further embodiments the clamping element may be a claw in which a workpiece is clamped between clamping jaws.

1. A clamping element, comprising:
a contact area on which a section of a workpiece can be placed,
at least one drive unit for moving the clamping element along a console of a machining device, wherein
the clamping element comprises a unit which is configured to detect individualised control signals transmitted via the power supply and to control the drive unit.

2. The clamping element according to claim 1, wherein the drive unit comprises an engagement element in order to be able to move the clamping element relative to the console.

3. The clamping element according to claim 1, wherein the clamping element comprises a base with protruding sections which are configured to cover side walls of the console in sections.

4. The clamping element according claim 1, wherein the unit for detecting control signals is connected to a sliding contact.

5. The clamping element according to claim 1, wherein the drive unit is an electric drive unit.

6. The clamping element according to claim 1, wherein the clamping element comprises two or more drive units, the two or more drive units being configured to act at opposite sides of the console.

7. The clamping element according to claim 1, wherein the unit for detecting control signals is configured to connect, based on an activation key, the drive unit of the clamping element to a strip conductor of the console, in order to move the clamping element.

8. A machining device for machining a plate-shaped workpiece, comprising:
a machine bed having at least one console extending in a first direction,
at least one clamping element, wherein the clamping element comprises a drive unit for moving the clamping element along the console, and
wherein the clamping element comprises a unit which is configured to detect individualised control signals transmitted via the power supply and to control the drive unit.

9. The machining device according to claim 8,
wherein a strip conductor extends along the console, and a sliding contact of the clamping element being connected to the strip conductor.

10. The machining device according to claim 8, wherein a modular unit extends along the console, which modular unit comprises a grid with which an engagement element of the drive unit can engage.

11. The machining device according to claim 8, wherein the clamping element comprises two or more drive units, the two or more drive units being configured to act at opposite sides of the console.

12. The machining device according to claim 8, wherein the machining device comprises a control unit having an encoder, in order to modulate control signals for controlling the drive unit.

13. The machining device according to claim 8, wherein the console can be moved along the machining table in a second direction, a movement of the clamping element and the console to occur simultaneously at times.

14. A method for moving a clamping element along a console, wherein the clamping element comprises a drive unit for moving the clamping element and a unit for detecting control signals, comprising:
detecting, by means of the unit, an individualised control signal transmitted via the power supply, and
controlling the drive unit based on the control signal detected by the unit.

15. The method according to claim 14, wherein the unit connects, based on an activation key, the drive unit of the clamping element to a strip conductor of the console in order to move the clamping element.
